(19) United States
(12) Patent Application Publication
(10) Pub. No.: US 2004/0251351 A1
(43) Pub. Date: Dec. 16, 2004

(54) Screening plant system

(76) Inventors: Paul Douglas, Swadlincote (GB); Terence Bratton, Swadlincote (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/482,905

(22) PCT Filed: Jul. 5, 2002
(86) PCT No.: PCT/GB02/03105

(30) Foreign Application Priority Data
Jul. 5, 2001 (GB) 0116397.1

(51) Int. Cl. B03B 7/00

(52) U.S. Cl. 241/101.74

(57) ABSTRACT

A system and method for carrying out a combined crushing and screening operation on a supply of bulk raw material, and utilizing a crusher and a self-propelled screening plant to receive a supply of crushed material from the crusher via an input end of the plant, in which the input end of the screening plant includes a preliminary screening unit which separates over-sized crushed material and directs the remainder of the material to a screen box of the plant, and a conveyor unit cooperates with the screening plant to receive over-sized material from the preliminary screening unit and discharges the over-sized material to a stockpile and/or recycles the material to the crusher for further crushing. The conveyor unit may be coupled with the screening plant via lockable lift arms and cooperating housing when they work together to form a composite assembly which can be maneuvered on site when required.

This invention relates to a screening plant system, and to a method of carrying out a number of different screening operations on site.

A screening plant is usually employed in a quarry site, and is provided with a supply of raw material in bulk form, usually from a crusher, and operates to screen the crushed material into different size ranges e.g. ballast, gravel and sand.

In some circumstances, a screening plant is a substantially permanent installation, and which is assembled on site at a fixed location, and which operates to screen crushed material until such time as the potential of the site has been exhausted, when the plant may be scrapped, or disassembled and transported to another site, if it still has a reasonable working “life” remaining.

However, in recent years, it has become the practice to employ readily transportable screening plant, which can be towed from one site to another (or transported on a low loader) with the operating components e.g. discharge conveyors, adjusted to a transport position. The plant can also be transported from one position to another in a particular site. In either event, after taking-up the new location, it can readily be adjusted from its transport mode to take-up its operative mode, with the operating components deployed to the operative positions.

It is also known to provide a self-propelled screening plant, which can manoeuvre itself around a particular site so as (1) to be positioned in a suitable position to receive a bulk supply of crushed raw material e.g. directly from a crushing plant and/or (2) to form stockpiles of screened material at required storage locations on site, and by movement of the plant to increase the size of the stockpiles to make maximum usage of the storage area available.

One known example of a self-propelled screening plant is the Turbotrac machine made and sold by the Extec Group of Companies, and which embodies patentable features, and including features protected under GB patent 2331033B, to which reference is directed. This is a compact machine which is highly manoeuvrable, via a short length of crawler tracks (relative to the overall length of the chassis), and a favourable weight distribution of the operating components (engine, input hopper, screen box or boxes, and discharge conveyors).

The present invention has been developed primarily, though not exclusively, with a view to provide enhanced usage of a self-propelled screening plant, such as that disclosed in GB 2331033B.

According to a first aspect of the invention there is provided a system for carrying out a combined crushing and screening operation on a supply of bulk raw material, and utilising a crusher to crush a supply of bulk raw material fed thereto, and a self-propelled screening plant to receive a supply of crushed material from the crusher via an input end of the plant, said plant being operative to screen the crushed material into at least one size range of crushed material;

in which:

the input end of the screening plant includes a preliminary screening unit which is operative to separate out over-sized crushed material from the supply of crushed material and to direct the remainder of the material to at least one screen box of the plant; and

a conveyor unit is co-operative with the screening plant to receive over-sized material from the preliminary screening unit, and operative (a) to discharge the over-sized material to a stockpile and/or (b) to re-cycle the material to the crusher for a further crusher treatment, said conveyor unit being capable of being coupled with the screening plant when they work together, and of being an independent free standing unit when uncoupled from the screening plant.

Preferably, the conveyor unit is capable of being coupled with the screening plant to form a composite assembly which is manoeuvrable on site, with the conveyor unit being supported by the screening plant.

The coupling together of the conveyor unit and the screening plant may be provided by interengageable lift arms and housings.

According to a second aspect of the invention there is provided a self-propelled screening plant which comprises:

an input end for receiving a supply of crushed material;

a screen box;

a preliminary screening unit provided at the input end and operative to separate out over-sized crushed material from the supply of crushed material and to direct the remainder of the material to the screen box; and

a conveyor unit co-operative with the screening plant to receive over-sized material from the preliminary screening unit, and operative (a) to discharge the over-sized material to a stockpile and/or (b) to re-cycle the material to the crusher for a further crusher treatment, said conveyor unit being capable of being coupled with the screening plant when they work together and of being an independent freestanding unit when uncoupled from the screening plant.

Preferably, the coupling together of the conveyor unit and the screening plant may be provided by interengageable lift arms and housings.

Power to operate the separate conveyor unit may be transmitted via an umbilical connection to the screening plant.

The conveyor unit may have a tandem arrangement of parallel conveyors, extending generally perpendicular to the longitudinal axis of the plant, and the input end of the plant has a discharge chute or the like which discharges over-sized material to one or the other of the conveyors of the conveyor unit.

One conveyor of the conveyor unit may be operated to form a stockpile of over-sized material, and another one of the conveyors may be operated to deliver over-sized material which can be recycled to a crusher when the latter is located adjacent thereto.

According to a third aspect of the invention there is provided a method of carrying out a combined crushing and screening operation on a supply of bulk raw material, and utilising a crusher to crush a supply of bulk raw material fed thereto and to deliver a supply of crushed material to an input end of a self-propelled screening plant which operates to screen the crushed material into at least two size ranges of screened material;

in which the input end of the screening plant includes a preliminary screening unit which separates out over-sized crushed material from the supply of crushed material and which directs the remainder of the material to at least one screen box of the plant which screens the material into at least two screened size ranges of material and then delivers the screened material to discharge means which forms separate stockpiles of screened material; and,

the oversized material is discharged to a separate free-standing conveyor unit which discharges the oversized material to (a) a further stockpile and/or (b) to be recycled to the crusher for a further crushing treatment.

Therefore, in carrying out the method of the invention, improved usage of the screening plant is possible, in that a number of different operating options are available. Thus, the plant may be used to perform its own screening functions, which typically may be separation into three size ranges, and which may be discharged to respective stockpiles via a pair of side-discharge conveyors and a tail-discharge conveyor. In addition, the preliminary screening unit may be operated to provide an additional screening function (for stockpile and/or recycling as required).

Alternatively, the screening plant may be manoeuvred away from the separate conveyor unit, and carry out screening operations at any other required location on site.

The features of the invention therefore provide improved utilisation of quarry equipment on site, with greater flexibility to operatives than is available with existing equipment.

Preferably, the screening plant and the separate conveyor unit are relatively adjustable so as to facilitate relative movement of the plant and the conveyor unit towards and away from co-operative interengagement.

The plant preferably is able to manoeuvre itself via a set of crawler or endless tracks, and the conveyor unit may have adjustment means to facilitate height adjustment to co-operate with the input end of the plant. Preferably, power to operate the conveyor unit is transmitted via an umbilical connection to the screening plant.

The conveyor unit may have a tandem arrangement of parallel conveyors, extending generally perpendicular to the longitudinal axis of the plant. The input end of the plant may have a discharge chute or the like to discharge oversized material to one or the other of the conveyors of the conveyor unit.

Thus, one conveyor may be arranged to form a stockpile of oversized material, and the other conveyor may deliver the oversized material for recycling to the crusher.

In a further aspect, the invention also is concerned with the conveyor unit per se, for use with (a) the self-propelled screening plant and/or (b) the crusher.

A preferred embodiment of the invention will now be described in detail, by way of example only, with reference to the accompanying drawings, in which:

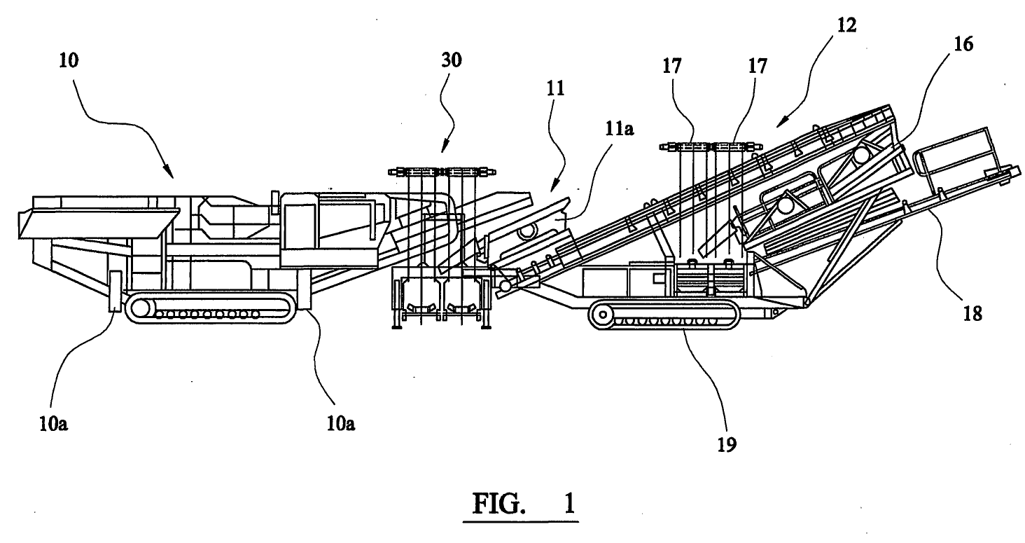

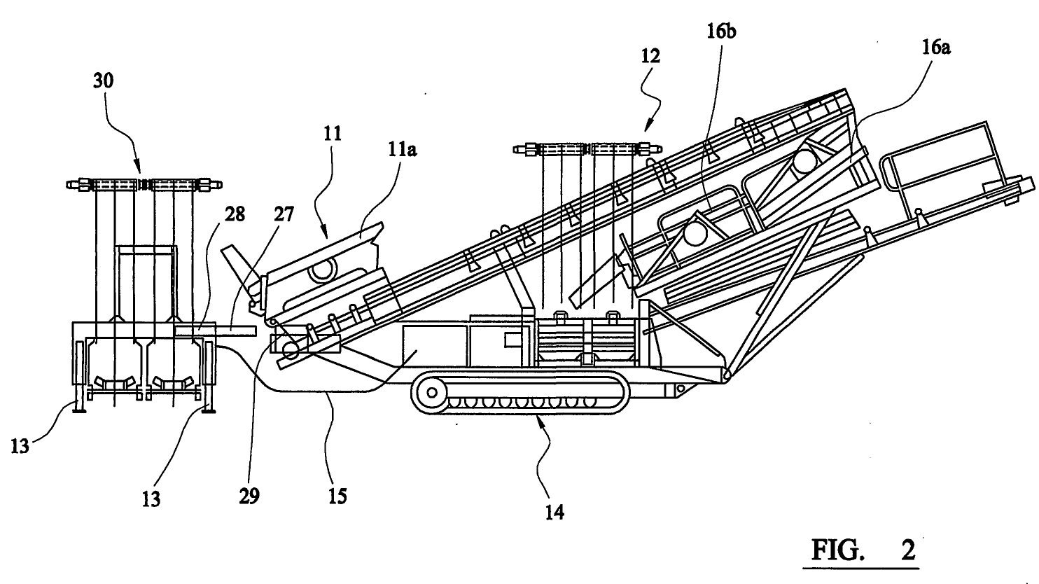

FIG. 1 is a side view of a crusher and screening installation or system according to the invention, and for use in carrying out a method according to the invention, and showing a self-propelled crusher which receives a bulk supply of crushable material, a self-propelled screening plant having an input end arranged to receive crushed material, and a free-standing separate conveyor unit arranged between the crusher unit and the screening plant to receive oversized crushed material from the input end of the screening plant;

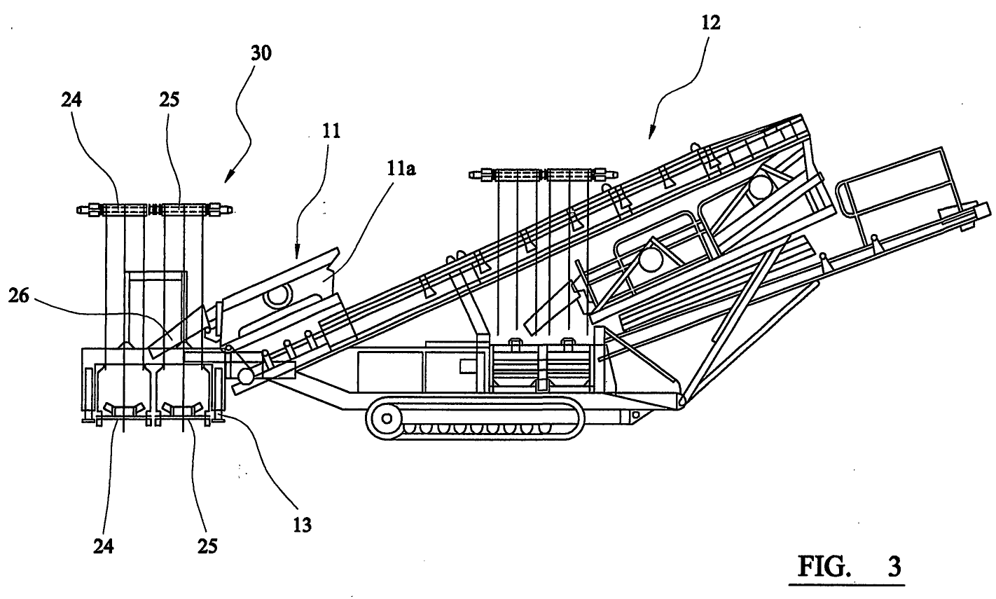

FIG. 2 is a side view, showing in more detail the co-operation between the free-standing conveyor unit and the self-propelled screening plant, ready for relative movement to a position of full co-operating interengagement;

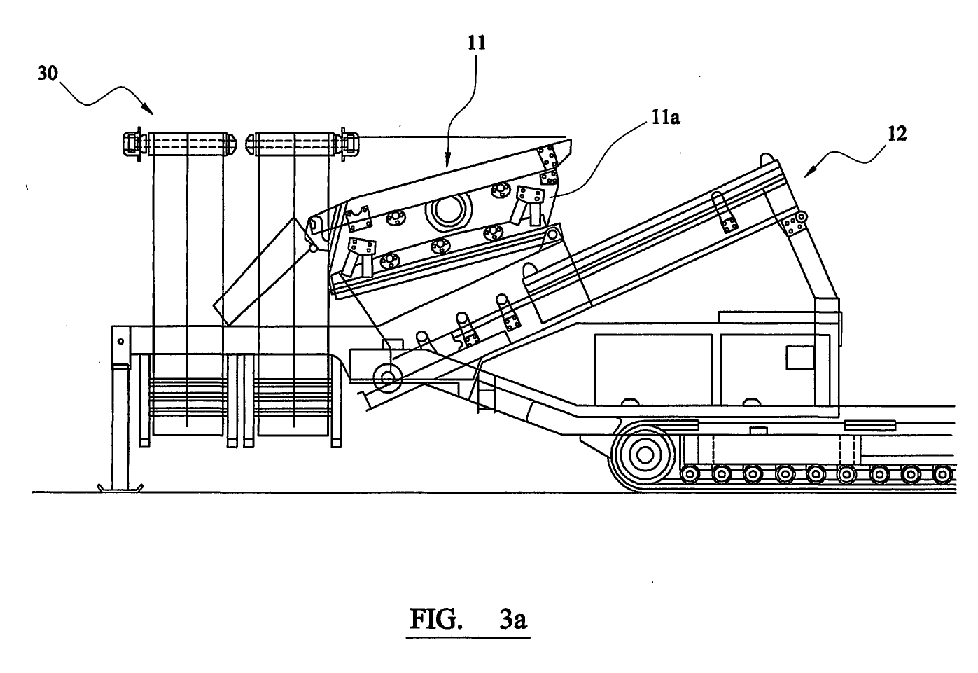

FIG. 3 is a side view of the self-propelled screening plant and the conveyor unit, when transversely adjusted to a position of co-operating engagement;

FIG. 3a is a similar side view to FIG. 3, but of a detail and to an enlarged scale, showing an alternative operating mode; and

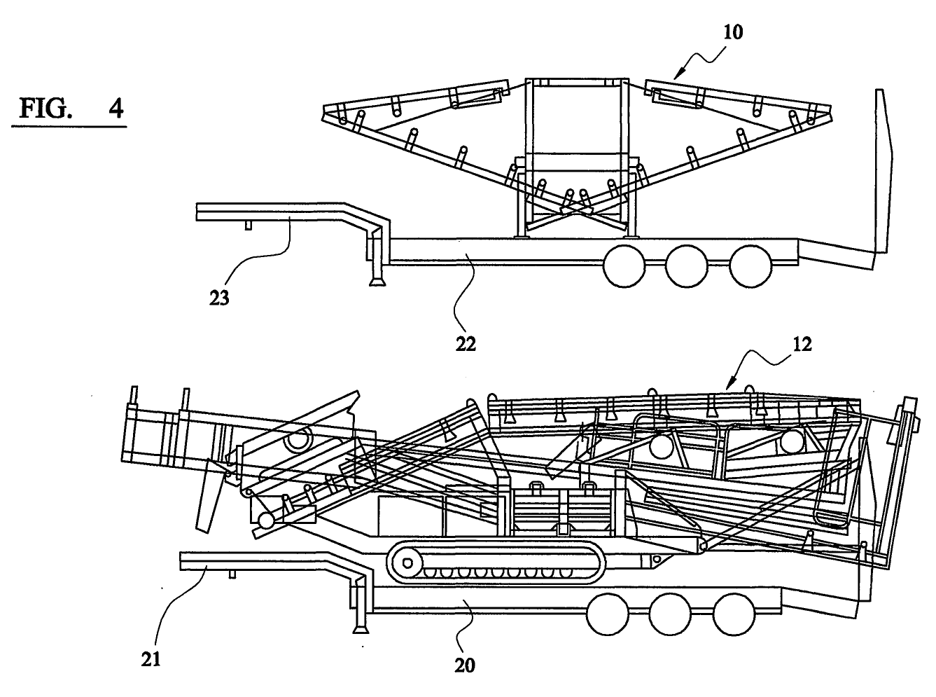

FIG. 4 shows the conveyor unit and the self-propelled screening plant each adjusted to a transport mode, and mounted on a respective low loader for transport from one site to another.

Referring first to FIG. 1 of the drawings, a screening plant assembly, and method of carrying out a number of different screening operations, will now be described in detail with reference to FIG. 1 of the drawings. There is shown apparatus capable of carrying out a combined crushing and screening operation on a supply of bulk raw material, and utilising a self-propelled crusher unit 10 which is capable of crushing a supply of bulk raw material fed thereto, and to deliver a supply of crushed material to an input end 11 of a self-propelled screening plant 12 which operates to screen the crushed material into at least two size ranges of screened material. The crusher unit 10 may be of the type made and sold by the Extec Group of companies under the Trade Mark IMPACTOR, and more details of which can be had from WO99/49976.

FIG. 2 shows a free-standing conveyor unit 30 and the screening plant 12 in a laterally separated mode, but with the conveyor unit 30 vertically adjusted in height by lowerable jacking legs 13, to allow the plant 12 to propel itself via its endless tracks 14 into co-operative interengagement with the conveyor unit 30, as shown in FIG. 1, and also more clearly in FIG. 3. An umbilical hydraulic connection 15 connects the conveyor unit 30 to the power output of the engine driving the screening plant 12, and provides energy to operate the operating components of the conveyor unit 30.

The input end 11 of the screening plant 12 takes the form of a vibratory screen box, and which includes a preliminary screening unit 11a which separates out oversized crushed material from the supply of crushed material from the crusher 10, and which directs the remainder of the material to at least one screen box 16 of the plant 12 (two screen boxes 16a and 16b are shown in FIG. 2) which screens the material into at least two screened size ranges of material and then delivers the screened material to discharge means which forms separate stockpiles of screened material. In the illustrated embodiment, the discharge means comprises two separate side-discharge conveyors 17 and a tail-discharge conveyor 18.

However, the oversized material which is separated out in the preliminary screening unit at the input end 11 is discharged to the separate free-standing conveyor unit 11, and which discharges the oversized material (a) to a further stockpile and/or (b) to be recycled to the crusher 10 for a further crushing treatment.

The self-propelled screening plant 12 is a highly manoeuvrable machine, via short length of its crawler tracks 19, and a favourable weight distribution of the operating components, such as the engine, input hopper at input end 11, screen box or boxes 16, and discharge conveyors 17 and 18. Conveniently, the screening plant 12 takes the form of a plant as disclosed in more detail in GB patent 2331033B, to which reference is directed. However, other designs of self-propelled screening plant may be used in carrying out the method of the invention and which may be wheeled or tracked vehicles.

Therefore, FIG. 1 shows the co-operation between crusher unit 10, conveyor unit 30 and self-propelled screening plant 12, and this effectively provides a “five way split screening plant”, combined with a crushing plant. FIG. 2 shows a power coupling between the screening plant 12 and the conveyor unit 30, via umbilical connection 15 which is operative to raise and lower the jacking legs 13 for alignment purposes, and to allow the plant 12 to be driven into a position of co-operative interengagement, as shown in FIGS. 1 and 3.

FIG. 2 shows the conveyor unit 30 mechanically separate from the plant 12, and when they have moved into a co-operating relation as shown in FIGS. 1 and 3, a pair of laterally spaced locking arms 27 (projecting from the frame 28 of the conveyor unit 30) are received by housings 29 at the input end 11 of the plant 12 to lock them together. The locking arms 27 may engage therefore with the end frame of the plant 12 in the manner of a fork lift arrangement, and are then locked in position e.g. by locking pins.

Evidently, as an alternative fork-lift type arms may project from the end frame of the plant 12, and be received by housings or pockets in the frame of the conveyor circuit 30.

Then, upon lifting of the legs 13 (to the raised position shown in FIG. 3), the conveyor unit 30 is coupled with the plant 12 as a composite assembly (with the conveyor unit 30 being supported by the screening plant 12) which can be manoeuvred on site e.g. to approach the crusher 10, or to another location where a supply of crushed material is available for supply to the input end 11.

When the three components have been adjusted to a required cooperating position e.g. as shown in FIG. 1, the legs 13 are then lowered (from the raised position of FIG. 3) to engage the ground and give stability and support to the conveyor unit 30 (and also the plant 12 to which it is coupled).

In FIG. 1, the crusher 10 is shown in a position of cooperation with the conveyor unit 30, but prior to lowering of its support legs 10a to engage the ground, again to give stability and support while the crusher is operating.

FIG. 3 therefore shows the conveyor section 30 locked in position, and with the jacking legs 13 raised, to allow the plant 12 to be self-propelled around site, when it is required to carry out separate screening operations at a different location. FIG. 4 shows the plant 12 adjusted to a transport mode, and carried on a load platform 20 of a trailer 21, and also shows the conveyor unit 30 adjusted to a transport mode, and supported on load platform 22 of a separate trailer 23.

The conveyor unit 30 has a tandem arrangement of parallel conveyors 24 and 25, extending generally perpendicular to the longitudinal axis of the plant 12. The input end 11 of the plant 12 has a discharge chute 26 (or the like) to discharge oversized material from the preliminary screening unit, and to one or the other of the conveyors 24, 25 of the conveyor unit. One of the conveyors may be arranged to form a stockpile of oversized material, and the other conveyor may be arranged to deliver the oversized material for recycling to the crusher 10.

To conclude, there is disclosed herein a novel system and method of carrying out a combined crushing and screening operation on a supply of bulk raw material, and a novel assembly for use in carrying out the method.

The invention also is concerned with the conveyor unit per se, for use with the self-propelled screening plant and/or with the crusher.

1. A system for carrying out a combined crushing and screening operation on a supply of bulk raw material, and utilizing a crusher to crush a supply of bulk raw material fed thereto, and a self-propelled screening plant to receive a supply of crushed material from the crusher via an input end of the plant, said plant being operative to screen the crushed material into at least one size range of crushed material;
in which;
the input end of the screening plant includes a preliminary screening unit which is operative to separate out over-sized crushed material from the supply of crushed material and to direct the remainder of the material to at least one screen box of the plant; and
a conveyor unit is co-operative with the screening plant to receive over-sized material from the preliminary screening unit, and operative (a) to discharge the over-sized material to a stockpile and/or (b) to re-cycle the material to the crusher for a further crusher treatment, said conveyor unit being capable of being coupled with the screening plant when they work together, and of being an independent free standing unit when uncoupled from the screening plant.

2. A system according to claim 1, in which the conveyor unit is capable of being coupled with the screening plant to form a composite assembly which is maneuverable on site with the conveyor unit being supported by the screening plant.

3. A system according to claim 2, in which the coupling together of the conveyor unit and the screening plant is provided by inter-engaging lift arms and housings.

4. A self-propelled screening plant which comprises:
an input end for receiving a supply of crushed material;
a screen box;
a preliminary screening unit provided at the input end and operative to separate out over-sized crushed material from the supply of crushed material and to direct the remainder of the material to the screen box; and
a conveyor unit co-operative with the screening plant to receive over-sized material from the preliminary screening unit, and operative (a) to discharge the oversized material to a stockpile and/or (b) to re-cycle the material to the crusher for a further crusher treatment, said conveyor unit being capable of being coupled with the screening plant when they work together and of being an independent freestanding unit when uncoupled from the screening plant.

5. A self-propelled screening plant according to claim 4, in which the conveyor unit and the screening plant are capable of being coupled together by inter-engaging lift arms and housings.

6. A self-propelled screening plant according to claim 4, in which the conveyor unit has a tandem arrangement of parallel conveyors, extending generally perpendicular to the longitudinal axis of the plant, and the input end of the plant has a discharge chute or the like which discharges over-sized material to one or the other of the conveyors of the conveyor unit.

7. A self-propelled screening plant according to claim 6, in which one conveyor of the conveyor unit is operable to form a stockpile of over-sized material.

8. A self-propelled screening plant according to claim 6, in which one of the conveyors of the conveyor unit is operative to deliver over-sized material for recycling to a crusher, when the latter is located adjacent to the conveyor unit.

9. A self-propelled screening plant according to claim 4, in which power to operate the conveyor unit is transmitted via an umbilical connection to the screening plant.

10. A self-propelled screening plant according to claim 4, in which the screening plant has a set of crawler or endless tracks to enable the plant, or the plant and the conveyor unit when coupled therewith, to be maneuvered on site, and in which the conveyor unit has adjustment means to facilitate height adjustment to cooperate with the input end of the plant.

11. A method of carrying out a combined crushing and screening operation on a supply of bulk raw material, and utilizing a crusher to crush a supply of bulk raw material fed thereto, a self-propelled screening plant to receive a supply of crushed material from the crusher via an input end of the plant and which is operative to screen the crushed material into at least two size ranges of screened material;
in which the input end of the screening plant includes a preliminary screening unit operative to separate out over-sized crushed material from the supply of crushed material and to direct the remainder of the material to at least one screen box of the plant for screening the material into at least two screened size ranges of material to be delivered to discharge means which forms separate stockpiles of screened material; and,
a separate conveyor unit co-operative with the screening plant to receive the oversized material discharged which discharges the oversized material from the preliminary screening unit and to discharge to (a) a further stockpile and/or (b) to be recycled to the crusher for a further crushing treatment.

12. A method according to claim 11, in which the screening plant is maneuvered away from the separate conveyor unit, and carries out screening operations at any other required location on site.

13. A method according to claim 11, in which the screening plant and the separate convey screened material for unit are relatively adjustable to facilitate relative movement of the plant and the conveyor unit towards and away from co-operative interengagement.

14. A method according to claim 11, in which the plant is able to maneuver itself via a set of crawler or endless tracks, and the conveyor unit has adjustment means to facilitate height adjustment to co-operate with the input end of the plant.

15. A method according to claim 11, in which power to operate the separate conveyor unit is transmitted via an umbilical connection to the screening plant.

16. A method according to claim 11, in which the conveyor unit has a tandem arrangement of parallel conveyors, extending generally perpendicular to the longitudinal axis of the plant, and the input end of the plant has a discharge chute or the like which discharges oversized material to one or the other of the conveyors of the conveyor unit.

17. A method according to claim 16, in which one conveyor of the conveyor unit is operated to form a stockpile of oversized material.

18. A method according to claim 16, in which one of the conveyors of the conveyor unit is operated to deliver oversized material which is recycled to the crusher.

19. A freestanding conveyor unit for use in a method according to claim 11.
